(19) United States
(12) Patent Application Publication
(10) Pub. No.: US 2008/0218802 A1
(43) Pub. Date: Sep. 11, 2008

(54) Device calibration method with accurate planar control

(75) Inventors: Vishal Monga, Webster, NY (US); Raja Bala, Webster, NY (US)

Correspondence Address: ORTIZ & LOPEZ, PLLC, P. O. BOX 4484, ALBUQUERQUE, NM, 87196-4484, US

(73) Assignee: Xerox Corporation

(21) Appl. No.: 11/716,283

(22) Filed: Mar. 9, 2007

(51) Int. Cl. G06K 15/00

(52) U.S. Cl. 358/2.1

(57) ABSTRACT

A device calibration method based on two-dimensional calibration transform that allows complete control of two-dimensional planes in the three-dimensional CMY (Cyan, Magenta, and Yellow) cube. Two-dimensional planes can be identified in the three-dimensional CMY cube as a primary plane and projected onto two-dimensional calibration lookup tables (LUTs) for C, M, and Y. The LUTs are filled with CMY colorant values that will maintain a fixed color (e.g. CIELAB) response within the chosen primary planes. There are three possible realizations depending upon which primary diagonal CMY plane is chosen. This technique can be used to calibrate an engine over time and to bring two or more engines to the same desired state.

### TECHNICAL FIELD

Embodiments are generally related to data-processing methods and systems. Embodiments are also related to the field of color image/text printing and display systems. Embodiments are additionally related to methods for calibrating color output devices with accurate planar control.

### BACKGROUND OF THE INVENTION

Achieving consistent and high quality color reproduction in a color imaging system necessitates a comprehensive understanding of the color characteristics of various devices in the system. This can be done through a process of device characterization and calibration. The characterization transforms a multidimensional correction that maps device independent colors to device dependent CMYK (Cyan, Magenta, Yellow and Black) colors. The calibration transform is a mapping in device dependent space (e.g. from CMYK to C′M′Y′K′) that maintains a desired printer response. Since calibration is carried out frequently, it is desirable to make this process inexpensive and easy to execute. Additionally, the calibration transform is required to be computationally efficient with a reasonable memory requirement so that it can be incorporated into high-speed real-time printing paths.

Calibration architectures vary in the degree of control they provide and the underlying cost, i.e. required measurements, storage and/or computation. As an example, traditional one-dimensional calibration implemented by using simple one-dimensional LUTs (Look-up Tables) from CMYK to C′M′Y′K′ is not only the most cost effective, but also significantly limits the control available over the device color gamut. A typical example of this limited control is that one-dimensional Tone Reproduction Curves (TRCs) in a printer can be used either to ensure gray balance along the C=M=Y axis or to provide a linear response in delta-E units along each of the individual (C, M and Y) axis, but not both. In this case equation (1) applies:

C′=f₁(C),M′=f₂(M),Y′=f₃(Y),K′=f₄(K) (1)

TRCs are obviously very efficient for real-time image processing. Memory requirements are also very minor for 8-bit processing; 256 bytes of memory are required for each separation's TRC for a total of 768 bytes of storage. It involves measuring step-wedges of pure C, M, Y and possibly patches near C=M=Y if gray-balance is desired. Corrections for the black (K) channel are derived independently by measuring a step-wedge of pure K. Either a one-dimensional desired response in terms of delta-E from paper is specified along the four primary channels, or a three-dimensional CIELAB (CIE 1976 L*a*b*) response is specified along a one-dimensional locus that satisfies certain monotonicity constraints. The former, i.e. control of individual colorant channels, is known as channel-wise linearization, while the latter scenario is typically seen in grey-balance calibration where C=M=Y are desired to render the (L*, 0, 0) locus. A typical one-dimensional calibration can be designed to meet one of the above two goals but not both.

On the other hand, three-dimensional calibration (3→1 LUTs for CMY, one-dimensional for K) and four-dimensional calibration transforms enable significantly more control but tend to require prohibitively large measurements, storage and/or real-time computation. In this case equation (2) applies:

C′=f₁(C,M,Y),M′=f₂(C,M,Y),Y′=f₃(C,M,Y) (2)

It is also conceivable to build a four-dimensional function that calibrates all four channels together. In this case equation (3) applies:

C′=f₁(C,M,Y,K),M′=f₂(C,M,Y,K),Y′=f₃(C,M,Y,K),K′=f₄(C,M,Y,K) (3)

The above transforms are traditionally used for characterization as opposed to calibration in current color management architectures. However its application can be considered for calibration as an option to motivate the recent progress in calibration methods. If sparse LUTs are used with interpolation, the processing might be too computationally intensive for high speed printing applications. A full resolution LUT with direct lookup avoids interpolation, but might be prohibitively large, especially if several LUTs are required for different media, halftones, etc. For 8-bit processing, a full three-dimensional LUT would require 3*(256)³ bytes=48 MB of storage. This becomes similar to characterization, typically involving a large number of measurements. Also, inversion of three-dimensional/four-dimensional forward transforms is required over the entire CMY/CMYK color gamut making the process computationally very expensive.

Referring to FIG. 1 a traditional two-dimensional calibration transformation system 100 is illustrated as described in Patent Application Publication No. 20040257595 filed Jun. 18, 2003 by Sharma et al, entitled “TWO-DIMENSIONAL CALIBRATION ARCHITECTURES FOR COLOR DEVICES.” Input control values 102, 104 and 106 are respectively associated with colors C, M and Y as indicated in FIG. 1. System 100 further includes a calibration transformation 130 that is composed generally of calibration determined two-dimensional LUTs 122, 124 and 126. System 100 can permit the use of two-dimensional LUTs 122, 124 and 126 for calibration transformation 130 based on mapping input CMY control values 102, 104 and 106 to output C′M′Y′ control values indicated respectively by arrows 112, 114 and 116. The calibration transformation 130 can be expressed in general terms, by utilizing two intermediate control variables for each output variable as a function of input CMY, such that the output C′ M′ and Y′ are determined by the corresponding two intermediate variables, as indicated by equations (4) to (9) below:

(s₁,t₁)=vᵢ₁(C,M,Y) (4)

(s₂,t₂)=vᵢ₂(C,M,Y) (5)

(s₃,t₃)=vᵢ₃(C,M,Y) (6)

C′=f₁(s₁,t₁) (7)

M′=f₂(s₂,t₂) (8)

Y′=f₃(s₃,t₃) (9)

where sₖ, tₖ are intermediate variables that depend on the input CMY control values 102, 104 and 106. The output C′ is determined by s₁ and t1, the output M′ is determined by s₂ and t₂, and the output Y′ is determined by s₃ and t₃. Three two-dimensional LUTs 122, 124 and 126 can be used to implement the calibration transformation 130. The control value 106 associated with color K is handled independently through one-dimensional LUT 128 for mapping input K to output K′ as indicated by arrow 118. The use of full resolution lookup without interpolation will incur minimal computational cost, and still result in reasonable storage and memory requirements for high end printing applications, i.e. 128 Kb for each of the C, M, Y LUTs (as opposed to 48 Mb or higher for three-dimensional/four-dimensional calibration.

The particular method described in A2066 for filling the 2-D LUTs generates calibration transforms for selected one-dimensional loci within the 2-D LUTs, and performs interpolation between these loci to fill in the remaining sections of the 2-D LUTs. While the calibration is very accurate along the selected loci, it may be inaccurate in regions outside of these loci where interpolation is used to approximate the calibration transform. Furthermore, certain loci are only partially controlled in that only a single channel is calibrated to meet a specified 1-dimensional aim; while interactions with other colorants are not taken into account. This can also produce an inaccurate calibration transform along these loci.

In an effort to address the foregoing difficulties, the present inventors suggests an improved calibration method based on two-dimensional transforms that allows control of entire two-dimensional planar regions sliced out of the three-dimensional CMY cube. The calibration strategy significantly outperforms all prior one-dimensional and two-dimensional methods for device calibration. The method of enabling full planar control captures the non-linearity in the calibration transform missed by these previous multi-axis methods and offers superior calibration with no extra storage compared to existing two-dimensional calibration methods, and with only modest computational overhead.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide improved data-processing methods and systems.

It is another aspect of the present invention to provide improved color printing methods and display systems.

It is a further aspect of the present invention to provide an improved two-dimensional color calibration method with accurate planar control.

The aforementioned aspects and other objectives and advantages can now be achieved as described herein. A device calibration method based on two-dimensional calibration transform that allows complete control of two-dimensional planes in the three-dimensional CMY (Cyan, Magenta, and Yellow) cube is developed. Two-dimensional planes can be identified in the three-dimensional CMY cube as primary plane and projected onto two-dimensional calibration lookup tables (LUTs) for C, M, and Y. The LUTs are filled with CMY colorant values that will maintain a fixed color (e.g. CIELAB) response within the chosen primary planes.

There are three possible realizations depending upon which primary diagonal CMY plane is chosen—Cyan-Red, Magenta-Green or Yellow-Blue. The choice of realization can be made based on the device drifts and fleet calibration This technique can be used to calibrate an engine over time and to bring two or more engines to the same desired state. An exemplary embodiment elaborates realizations using the White-Cyan-Red-Black plane. This method allows complete control of two-dimensional planes with no interpolation and offers superior calibration with no extra storage. The planar control significantly enhances the ability of the calibration to maintain the device in a stable state over time.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a (prior art) traditional two-dimensional calibration transformation system;

FIG. 2 illustrates a flow diagram of color calibration steps in accordance with features of the present invention;

FIG. 3 illustrates a three-dimensional CMY cube showing primary two-dimensional plane used for cyan LUT, in accordance with a preferred embodiment;

FIG. 4 illustrates projection of primary two-dimensional plane onto cyan two-dimensional LUT, in accordance with an alternative embodiment.

FIG. 5 illustrates a portion of three-dimensional CMY cube showing primary and secondary two-dimensional planes that manifest in the magenta LUT, in accordance with a preferred embodiment;

FIG. 6 illustrates projection of primary two-dimensional plane onto magenta two-dimensional LUT, in accordance with an alternative embodiment.

FIG. 7 illustrates a portion of three-dimensional CMY cube showing primary and secondary two-dimensional planes that manifest in the yellow LUT, in accordance with a preferred embodiment;

FIG. 8 illustrates projection of primary two-dimensional plane onto yellow two-dimensional LUT, in accordance with a preferred embodiment.

FIG. 9 illustrates a system for implementing color calibration in accordance with features of the invention.

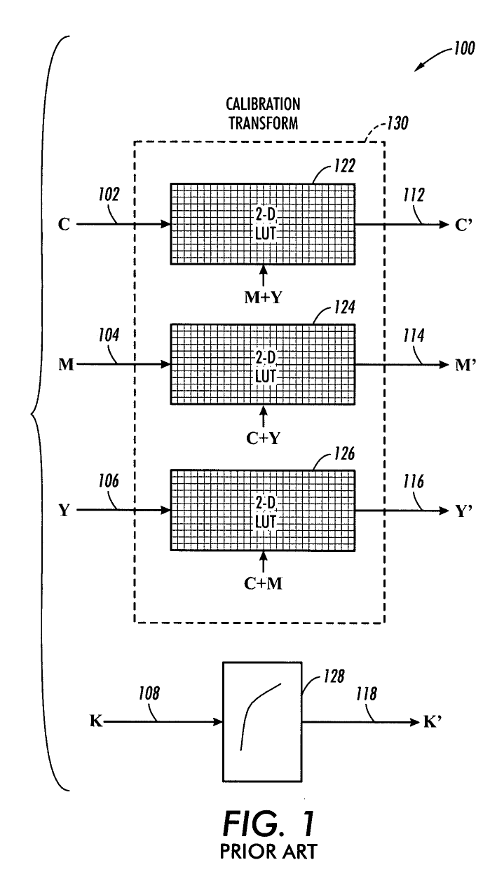

### DETAILED DESCRIPTION

The particular values and configurations discussed in these non-limiting examples can be varied and are cited merely to illustrate at least one embodiment and are not intended to limit the scope thereof.

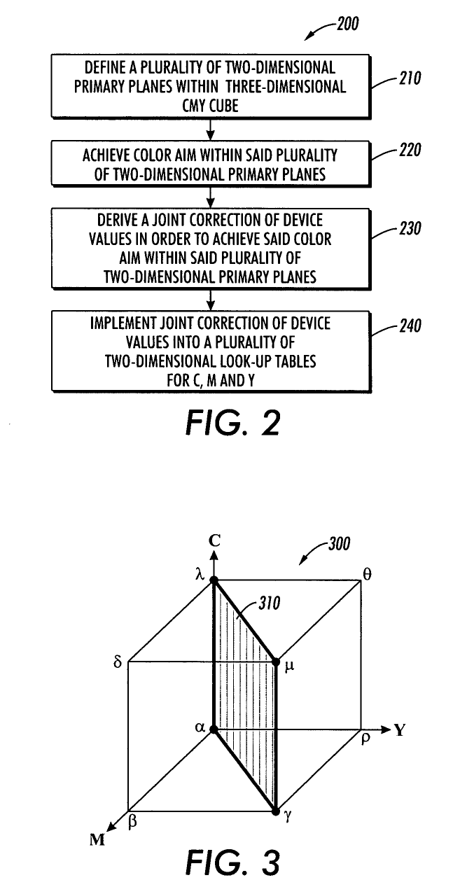

Described in detail herein are methods and systems that provide an improved two-dimensional color calibration method with accurate planar control. Referring to FIG. 2, a flow diagram 200 of method steps to achieve color calibration is illustrated. Calibrating a color output device begins by first defining a plurality of two-dimensional primary planes within a three-dimensional CMY cube as shown in Block 210. Next, a color aim to be achieved within said plurality of two-dimensional primary planes is defined as shown in Block 220. Then, a joint correction of device values is derived in order to achieve said color aim within said plurality of two-dimensional primary planes as shown in Block 230. Finally, joint correction of device values are implemented into a plurality of two-dimensional look-up tables for C, M and Y as shown in Block 240.

Referring to FIG. 3 a three-dimensional CMY cube 200 showing primary two-dimensional plane 210 used for cyan LUT is illustrated, in accordance with a preferred embodiment. Note that in FIGS. 2-8, identical or analogous parts or elements are generally indicated by identical reference numerals. The vertices of the CMY cube 200 includes cyan, green, yellow, white, black, red, magenta, and blue which is indicated by λ, θ, ρ, α, μ, Y, γ, δ. The primary plane 210 for accurate control can be selected that intersects with white, cyan, black and red vertices in the CMY cube 200. The primary plane 200 includes the neutral i.e. C=M=Y axis, hence gray balance is guaranteed.

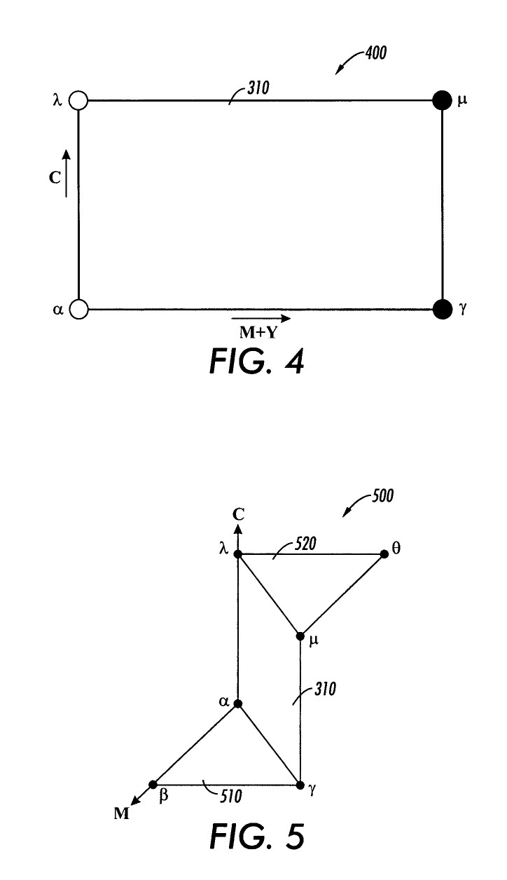

Referring to FIG. 4 projection of primary two-dimensional plane onto the two-dimensional LUT 300 for calibrating the cyan colorant is illustrated, in accordance with a preferred embodiment. The chosen primary plane 210 projects onto the entire domain of the cyan two-dimensional LUT 300. The vertices α, λ, Y, μ define the planar regions in the CMY cube 200. The LUT 300 is in exact correspondence with the two-dimensional planar region 210 as shown in FIG. 2. At each point within this 2-dimensional LUT, an output cyan value is filled to meet a specified aim.

Referring to FIG. 5 a portion of three-dimensional CMY cube showing primary and secondary two-dimensional planes 400 that manifest in the magenta LUT is illustrated, in accordance with a preferred embodiment. FIG. 4 illustrates primary plane 210 with vertices α, λ, Y, μ and secondary two-dimensional planes 410 and 420 with vertices α, β, Y and λ, μ, θ respectively that manifest in the Magenta LUT 400.

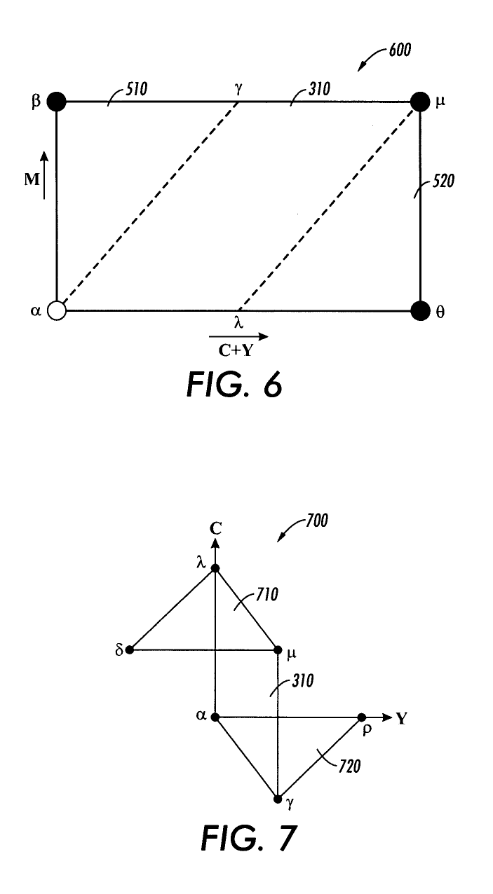

Referring to FIG. 6 projection of primary two-dimensional plane onto magenta two-dimensional LUT 500 is illustrated, in accordance with a preferred embodiment. The vertices α, λ, Y, μ define the planar regions in the CMY cube. The chosen primary plane 210 projects on to a fraction of the domain for magenta. The remaining portions of these two-dimensional LUTs can be used for controlling additional secondary planes 410 and 420.

Referring to FIG. 7 a portion of three-dimensional CMY cube showing primary and secondary two-dimensional planes 600 that manifest in the yellow LUT is illustrated, in accordance with a preferred embodiment. FIG. 6 illustrates primary plane 210 with vertices α, λ, Y, μ and secondary two-dimensional planes 610 and 620 with vertices α, Y, ρ and λ, μ, δ respectively that manifest in the Yellow LUT.

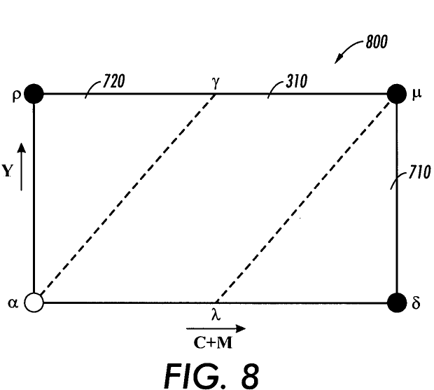

Referring to FIG. 8 projection of primary two-dimensional plane onto yellow two-dimensional LUT 700 is illustrated, in accordance with a preferred embodiment. The vertices α, λ, Y, μ define the planar regions in the CMY cube 200. The two-dimensional LUTs 300, 500 and 700 can be derived with the purpose of maintaining a fixed defined CIELAB aim within the primary plane 210 and secondary planes 410, 420 and 610, 620 described above. This can be the printer's response at some reference state, the aggregate response of a fleet of similar devices, or the response of a standard device (e.g. SWOP press). The two-dimensional LUTs 300, 500 and 700 are populated by solving a printer-model inversion problem, which obtains C, M, Y, K amounts required to produce a certain CIELAB color. Mathematically, this inversion can be stated as show in equation (9)

$$( {C}^{′} , {M}^{′} , {Y}^{′} ) = {arg min}_{C , M , Y ∈ [ 0 , 255 ]} {‖ {c}_{0} - c ‖}_{2} \\ where \\ {c}_{0} = {( {L}_{0} , {a}_{0} , {b}_{0} )}^{T} \\ and \\ c = {( L , a , b )}^{T} = pm ( C , M , Y ) \qquad ( 9 )$$

c₀ represents the vector of aim CIELAB values for the CMY being calibrated and c represents the output CIELAB vector from a printer-model describing the printer to be calibrated. The targets should contain CMYK patches chosen in the vicinity of the primary planes being calibrated.

The (C, M, Y) that lie on the primary diagonal plane 210 in FIG. 3 manifest in each of the C, M and Y calibration LUTs 300, 500 and 700 allowing for a joint population of these LUTs 300, 500 and 700. This ensures that the desired CIELAB color for all CMY on this primary plane 210 is achieved. This is in contrast to previous two-dimensional or multi-axis calibration schemes where most of these colors would be determined by an interpolation between a few selected one-dimensional axis that lie on this plane. For the other secondary planes 410, 420 and 610, 620 that manifest in the M and Y two-dimensional LUTs 500 and 700, a similar optimization problem to the one above is solved to obtain M′ and Y′ (i.e. calibrated Magenta and Yellow) that achieve a defined aim within these planes.

The above exemplary realization of planar control can alternatively be achieved by choosing a different primary plane, e.g. using magenta-green diagonal plane to populate the magenta two-dimensional calibration LUT, or using the yellow-blue diagonal plane for the yellow two-dimensional LUT. In those cases, the other two calibration LUTs (C and Y in case I and C and M in case II) would be made of three planar regions analogous to those shown for the M and Y two-dimensional LUTs 500 and 700 as illustrated in FIGS. 5 and 7.

In other words, there are three possible realizations of the proposed calibration method depending on which primary diagonal plane is chosen—Cyan-Red (the case elaborated upon in this invention), Magenta-Green or Yellow-Blue. The choice of which realization can be made based on the application, e.g. based on an understanding of how the device drifts, or how two printers in a fleet differ for applications in fleet calibration.

The experimental results are presented to demonstrate the benefits of planar control in printer calibration. The merits of the invention are explained by showing results for two different experiments. For each experiment, three different calibration methods are compared. They are one-dimensional gray-balance calibration for C, M and Y and a one-dimensional delta E from paper linearization calibration for K, two-dimensional calibration based on interpolating between several 1-D axes and proposed method of device calibration with planar control using two-dimensional LUTs. The primary and secondary planes were selected as shown in FIGS. 3-8. A special calibration target has been created that contained patches in the vicinity of these primary and secondary planes.

The temporal stability is evaluated by conducting the following experiment. The derived calibration is transformed (using each of the aforementioned calibration methods) at four different instances in time which is referred to as printer states S1 through S4. An in-gamut test target of 240 CMYK patches is printed at each printer state and through each calibration method. In addition, the test target is also processed through each calibration derived at S1 then printed at S2 through S4. The printer used in these experiments was a Xerox iGen 110 machine.

Table 1 quantifies the ability of each calibration method to maintain a set of desired CIELAB values along time. These numbers were generated by using the measurements of the in-gamut target printed at each printer state Si, I=1, 2, 3, 4 through each of the calibrations derived for printer state Si. Then, for any given calibration method, the pair-wise differences between CIELAB values from any two states Si and Sj were recorded and the maximum value (one corresponding to each patch in the test target) was computed across all possible pairs of printer states (Si, Sj). The aggregate statistics of those maximum values, i.e. peak-peak variability, are reported in Table 1.

It is inferred from Table 1 that planar control in device calibration significantly enhances the ability of the calibration to maintain the device in a stable state over time.

TABLE 1
Improved color consistency over time via planar control in calibration

| | | 95^{th} | |
|---|---|---|---|
| | Average | percentile | Maximum |
| | peak-to-peak | peak-to-peak | peak-to-peak |
| Calibration Method | ΔE | ΔE | ΔE |
| No recalibration | 7.10 | 14.21 | 15.42 |
| 1-D gray-balance calibration | 4.48 | 10.01 | 11.77 |
| 2-D calibration based on | 3.61 | 8.42 | 10.85 |
| interpolating between 1-D loci | | | |
| 2-D calibration with | 0.80 | 3.81 | 5.26 |
| planar control | | | |

The various calibrations for their ability to match the color response of a fleet of color devices are evaluated. The devices in this experiment were three Xerox iGen3 printers which refer to as iGen A, B and C. For each of the calibration methods, any device (iGen A, B or C) was calibrated to match a common CIELAB aim. For one-dimensional calibration this aim was defined for the neutral axis, for two-dimensional based on interpolation between one-dimensional axes and this aim was defined for each of the one-dimensional axes in the two-dimensional LUTs, and for the proposed method in this invention the aim was defined for the CMY values corresponding to the selected planar regions.

Table 2 shows the pairwise deltaE errors between printers A and C when they were calibrated using different calibration methods. In Table 3 the deviation of printer C from the CIELAB obtained by averaging the individual CIELAB values achieved by each printer is shown. The rest of the results, i.e. pairwise errors between A and B, B and C, and deviation of printers A and B from the common CIELAB followed a similar trend.

TABLE 2
Pairwise ΔE errors for fleet calibration: A vs. C

| | Average | 95^{th} percentile | Maximum |
|---|---|---|---|
| Calibration Method | ΔE | ΔE | ΔE |
| 1-D gray-balance calibration | 1.65 | 4.66 | 6.07 |
| 2-D calibration based on | 1.31 | 2.08 | 4.47 |
| interpolating between 1-D loci | | | |
| 2-D calibration with | 0.94 | 1.89 | 3.02 |
| planar control | | | |

The planar control enables significantly better fleet calibration. The one-dimensional grey-balance table is representative of the current calibration strategy implemented in DocuSP. Also, it may be seen that for fleet calibration no benefits are seen (over one-dimensional calibration) by even using the previous two-dimensional technique based on interpolation between one-dimensional loci. This is attributed to the severe non-linearity in the “true three-dimensional/four-dimensional calibration transform” that is approximated much better by the proposed calibration method which enables planar control.

TABLE 3
Deviation from a common aim, i.e. average CIELAB, of printer C

| | Average | 95^{th} percentile | Maximum |
|---|---|---|---|
| Calibration Method | ΔE | ΔE | ΔE |
| 1-D gray-balance calibration | 0.71 | 1.92 | 3.07 |
| 2-D calibration based on | 0.64 | 1.30 | 1094 |
| interpolating between 1-D loci | | | |
| 2-D calibration with | 0.51 | 1.11 | 1.64 |
| planar control | | | |

The proposed method is meritorious not only in accurate control of a higher-dimensionality, i.e. planar regions, but also in the control of certain loci. As an example of this, consider the white to red axis, i.e. C=0, M=Y a significantly different “red” hue for the three iGen3 printers is observed. In the previous two-dimensional calibration method the calibrated M and Y values along this axis were obtained by linearizing to the deltaE from paper locus along this axis. While a pure magenta or pure yellow shift can be accounted for, such an approach clearly cannot capture interactions between M and Y colorants that may contribute to hue shift along the red axis. In the proposed calibration, the CIELAB colors along this axis i.e. α-γ, shown in FIGS. 4 and 6 are exactly controlled and can hence account for all Magenta and Yellow interactions contributing to any red hue shift.

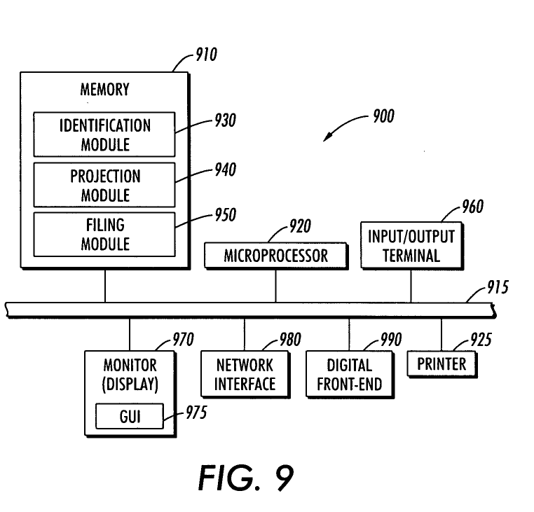

As shown in FIG. 9 the color calibration methods described herein can be implemented in a color calibration system 100 including a photocopier or printer. The color calibration system includes a microprocessor 910, a memory 920, an identification module 930 directed by said microprocessor and adapted for identifying 2-D planes of interest in 3-D CMY cubes, a projection module 940 directed by said microprocessor and adapted for projecting 2-D planes of interest onto 2-D calibration look up tables stored in said memory for C, M, and Y, and a filling module 950 directed by said microprocessor and adapted for filing 2-D calibration lookup tables with CMY colorant values that maintain a fixed color response within a chosen plane. It can be appreciated that modules are software based and can be carried out (executed) in a digital front end (DFE), input output terminal (IOT) or remote server where a system has network access.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for calibrating a color output device, comprising:
defining at least one two-dimensional primary plane within a multidimensional colorant space;
defining a color aim to be achieved within said at least one two-dimensional primary plane of two-dimensional primary planes;
deriving a joint correction of device colorant values in order to achieve said color aim within said at least one two-dimensional primary plane; and
filling joint correction data of device colorant values into at least one two-dimensional look-up table corresponding at least one colorant.

2. The method of claim 1 wherein the at least one colorant includes at least one of cyan (C), magenta (M), and yellow (Y), and the multidimensional colorant space is a three-dimensional CMY cube.

3. The method of claim 1 wherein said at least one two-dimensional look-up table comprises said at least one two-dimensional primary plane and at least one secondary plane.

4. The method of claim 2 wherein said at least one two-dimensional look-up table is in exact correspondence with said at least one two-dimensional primary plane depending upon said color aim.

5. The method of claim 3 wherein said at least one two-dimensional look-up table is manifested under an affine transformation with said at least one of two-dimensional secondary plane depending upon said color aim.

6. The method of claim 1 wherein said at least one two-dimensional primary plane has as vertices white-cyan-red-black, white-magenta-green-black, and white-yellow-blue-black.

7. The method of claim 1 wherein said at least one two-dimensional plane includes the neutral axis.

8. The method of claim 1 wherein said method allows complete three-dimensional control of said at least one two-dimensional plane.

9. A color calibration method enabling control over 2-D planar regions, comprising:
identifying at least one 2-D plane of interest in a multidimensional colorant space;
projecting said at least one 2-D plane of interest onto at least one 2-D calibration lookup table for the colorants; and
filling said at least one 2-D calibration lookup table with colorant values that maintain a fixed color response within a chosen plane;
wherein non-linearity in the calibration transform is captured.

10. Method of claim 9 wherein the colorants are C, M, and Y, and the multidimensional colorant space is a 3-D CMY cube

11. The method of claim 9, wherein calibration is applied over time across engines.

12. The method of claim 9, wherein calibration is executed by a digital front end in at least one of a photocopier or printer.

13. The method of claim 9, wherein calibration is executed by an input output terminal in at least one of a photocopier or printer.

14. The method of claim 9, wherein calibration is directed to at least one of a photocopier or printer remotely via online feedback control.

15. A color calibration system enabled with control over 2-D planar regions, comprising:
a microprocessor;
memory;
an identification module directed by said microprocessor and adapted for identifying 2-D planes of interest in 3-D CMY cubes;
a projection module directed by said microprocessor and adapted for projecting 2-D planes of interest onto 2-D calibration look up tables stored in said memory for C, M, and Y; and
a filling module directed by said microprocessor and adapted for filling 2-D calibration lookup tables with CMY colorant values that maintain a fixed color response within a chosen plane

16. A color calibration system of claim 14 wherein said image processing system further comprises software operational within a digital front end associated with a multi-functional device.

17. A color calibration system of claim 14 wherein said image processing system further comprises software operational within an input output terminal associated with a multi-functional device.

18. A color calibration system of claim 14 wherein said image processing system further comprises software operational within an input output terminal associated with a printer.

19. A color calibration system of claim 14 wherein said image processing system further comprises software operational within a digital front end associated with a printer.

20. A color calibration system of claim 14 wherein said image processing system includes network access and provides support to remote printers.
